(19) United States
(12) Patent Application Publication
(10) Pub. No.: US 2016/0304766 A1
(43) Pub. Date: Oct. 20, 2016

(54) USE OF INTERNAL OLEFIN SULFONATE COMPOSITION IN ENHANCED OIL RECOVERY

(71) Applicant: SHELL OIL COMPANY, HOUSTON, TX (US)

(72) Inventors: Julian Richard BARNES, Amsterdam (NL); Lori Ann CROM, Houston, TX (US); Nevena GOGOLAK, Amsterdam (NL); Paulus Johannes KUNKELER, Rotterdam (NL); Sipke Hidde WADMAN, Amsterdam (NL)

(21) Appl. No.: 15/193,268

(22) Filed: Jun. 27, 2016

(51) Int. Cl. C09K 8/584; E21B 43/16

(52) U.S. Cl. CPC C09K 8/584; E21B 43/16

(57) ABSTRACT

The invention relates to a method of treating a hydrocarbon containing formation wherein an internal olefin sulfonate composition is used, which comprises an internal olefin sulfonate and a second surfactant which is selected from the group consisting of: (1) a compound of the formula (I) R—O—[R′—O]ₓ—X wherein R is a hydrocarbyl group, R′—O is an alkylene oxide group, x is the number of alkylene oxide groups R′—O, and X is selected from the group consisting of: (i) a hydrogen atom; (ii) a group comprising a carboxylate moiety; and (iii) a group comprising a sulfonate moiety; (2) an alpha olefin sulfonate; and (3) an alkyl aromatic sulfonate.

### FIELD OF THE INVENTION

The present invention relates to a method of treating a hydrocarbon containing formation using an internal olefin sulfonate composition.

### BACKGROUND OF THE INVENTION

Hydrocarbons, such as oil, may be recovered from hydrocarbon containing formations (or reservoirs) by penetrating the formation with one or more wells, which may allow the hydrocarbons to flow to the surface. A hydrocarbon containing formation may have one or more natural components that may aid in mobilising hydrocarbons to the surface of the wells. For example, gas may be present in the formation at sufficient levels to exert pressure on the hydrocarbons to mobilise them to the surface of the production wells. These are examples of so-called “primary oil recovery”.

However, reservoir conditions (for example permeability, hydrocarbon concentration, porosity, temperature, pressure, composition of the rock, concentration of divalent cations (or hardness), etc.) can significantly impact the economic viability of hydrocarbon production from any particular hydrocarbon containing formation. Furthermore, the above-mentioned natural pressure-providing components may become depleted over time, often long before the majority of hydrocarbons have been extracted from the reservoir. Therefore, supplemental recovery processes may be required and used to continue the recovery of hydrocarbons, such as oil, from the hydrocarbon containing formation. Such supplemental oil recovery is often called “secondary oil recovery” or “tertiary oil recovery”. Examples of known supplemental processes include waterflooding, polymer flooding, gas flooding, alkali flooding, thermal processes, solution flooding, solvent flooding, or combinations thereof.

In recent years there has been increased activity in developing new methods of chemical Enhanced Oil Recovery (cEOR) for maximising the yield of hydrocarbons from a subterranean reservoir. In surfactant cEOR, the mobilisation of residual oil is achieved through surfactants which generate a sufficiently low crude oil/water interfacial tension (IFT) to give a capillary number large enough to overcome capillary forces and allow the oil to flow (Lake, Larry W., “Enhanced oil recovery”, PRENTICE HALL, Upper Saddle River, New Jersey, 1989, ISBN 0-13-281601-6).

However, different reservoirs can have different characteristics (for example composition of the rock, crude oil type, temperature, water composition, salinity, concentration of divalent cations (or hardness), etc.), and therefore, it is desirable that the structures and properties of the added surfactant(s) be matched to the particular conditions of a reservoir to achieve the required low IFT. In addition, other important criteria may have to be fulfilled, such as low rock retention or adsorption, compatibility with polymer, thermal and hydrolytic stability and acceptable cost (including ease of commercial scale manufacture).

Compositions and methods for cEOR utilising an internal olefin sulfonate (I0S) as surfactant are described in U.S. Pat. No. 4,597,879, U.S. Pat. No. 4,979,564, U.S. Pat. No. 5,068,043 and “Field Test of Cosurfactant-enhanced Alkaline Flooding”, Falls et al., Society of Petroleum Engineers Reservoir Engineering, 1994.

In the present invention, it is desired to provide a method for cEOR utilising internal olefin sulfonates as surfactant. More in particular, it is desired to provide such method using an internal olefin sulfonate composition which may have an improved cEOR performance at a relatively high temperature and at a relatively high concentration of divalent cations, such as Ca²⁺ and Mg²⁺ cations. In practice, the temperature in a hydrocarbon containing formation may be as high as 60° C. or even higher. Further, said divalent cations may be present in water or brine originating from the hydrocarbon containing formation and/or generally in water or brine (from whatever source) which is used to inject the surfactant into the hydrocarbon containing formation. For example, sea water may contain 1,700 parts per million by weight (ppmw) of divalent cations and may have a salinity of 3.6 wt. %.

In general, surfactant stability at a high temperature is relevant in order to prevent a surfactant from being decomposed (for example hydrolyzed) at such high temperature. Internal olefin sulfonates (IOS) are known to be heat stable at a temperature of 60° C. or higher. However, in addition to being heat stable, a surfactant composition may also have to withstand a relatively high concentration of divalent cations, as mentioned above, for example 100 ppmw or more. For such a high concentration of divalent cations may have the effect of precipitating the surfactant out of solution. In general, and in particular at such a high concentration of divalent cations, the surfactant should have an adequate aqueous solubility since the latter improves the injectability of the fluid comprising the surfactant composition to be injected into the hydrocarbon containing formation. Further, an adequate aqueous solubility reduces loss of surfactant through adsorption to rock within the hydrocarbon containing formation.

Thus, in the present invention, it is desired to provide a method using a composition comprising an internal olefin sulfonate which may have an improved cEOR performance under the above-described conditions of high temperature and high divalent cation concentration, whilst at the same time having an adequate aqueous solubility, for example in terms of reducing the interfacial tension (IFT), as already described above. Further cEOR performance parameters other than said IFT, are optimal salinity and aqueous solubility at such optimal salinity. By “optimal salinity”, reference is made to the salinity of the brine present in a mixture comprising said brine (a salt-containing aqueous solution), the hydrocarbons (e.g. oil) and the surfactant(s), at which salinity said IFT is lowest. A good microemulsion phase behavior for the surfactant is desired since this is indicative for such low IFT. In addition, it is desired that at or close to such optimal salinity, said aqueous solubility of the surfactant is sufficient to good.

Thus, in the present invention, it is desired to improve one or more of the above-mentioned cEOR performance parameters for internal olefin sulfonate compositions.

### SUMMARY OF THE INVENTION

It was found that in a method of treating a hydrocarbon containing formation, wherein the temperature is 60° C. or higher and the concentration of divalent cations is 100 or more parts per million by weight (ppmw), an internal olefin sulfonate composition which may have one or more of such improved cEOR performance parameters, is a composition which additionally comprises a second surfactant which is selected from the group consisting of:

(1) a compound of the formula (I)

R—O—[R′—O]ₓ—X Formula (I)

wherein R is a hydrocarbyl group, R′—O is an alkylene oxide group, x is the number of alkylene oxide groups R′—O, and X is selected from the group consisting of: (i) a hydrogen atom; (ii) a group comprising a carboxylate moiety; and (iii) a group comprising a sulfonate moiety;

(2) an alpha olefin sulfonate; and

(3) an alkyl aromatic sulfonate.

Accordingly, the present invention relates to a method of treating a hydrocarbon containing formation, comprising the following steps:

a) providing the composition which comprises an internal olefin sulfonate and a second surfactant as described above to at least a portion of the hydrocarbon containing formation wherein the temperature is 60° C. or higher and the concentration of divalent cations is 100 or more parts per million by weight (ppmw); and

b) allowing the surfactants from the composition to interact with the hydrocarbons in the hydrocarbon containing formation.

### BRIEF DESCRIPTION OF THE DRAWINGS

FIG. 1A illustrates the reactions of an internal olefin with sulfur trioxide (sulfonating agent) during a sulfonation process.

FIG. 1B illustrates the subsequent neutralization and hydrolysis process to form an internal olefin sulfonate.

FIG. 2 relates to an embodiment for application in cEOR.

FIG. 3 relates to another embodiment for application in cEOR.

### DETAILED DESCRIPTION OF THE INVENTION

In the method of the present invention, an internal olefin sulfonate composition which comprises an internal olefin sulfonate and the above-described second surfactant, is used. Preferably, the weight ratio of the second surfactant to the internal olefin sulfonate is below 1:1. Further, preferably, the weight ratio of the second surfactant to the internal olefin sulfonate is at least 1:100, more preferably at least 1:50, more preferably at least 1:20 and most preferably at least 1:10. Still further, preferably, the weight ratio of the second surfactant to the internal olefin sulfonate is at most 1:5.7, more preferably at most 1:4.0, more preferably at most 1:2.3, more preferably at most 1:1.5. In a case where the internal olefin sulfonate composition contains a surfactant other than an internal olefin sulfonate and other than the above-described second surfactant, the weight of such other surfactant should be added to the weight of internal olefin sulfonate when calculating said weight ratio.

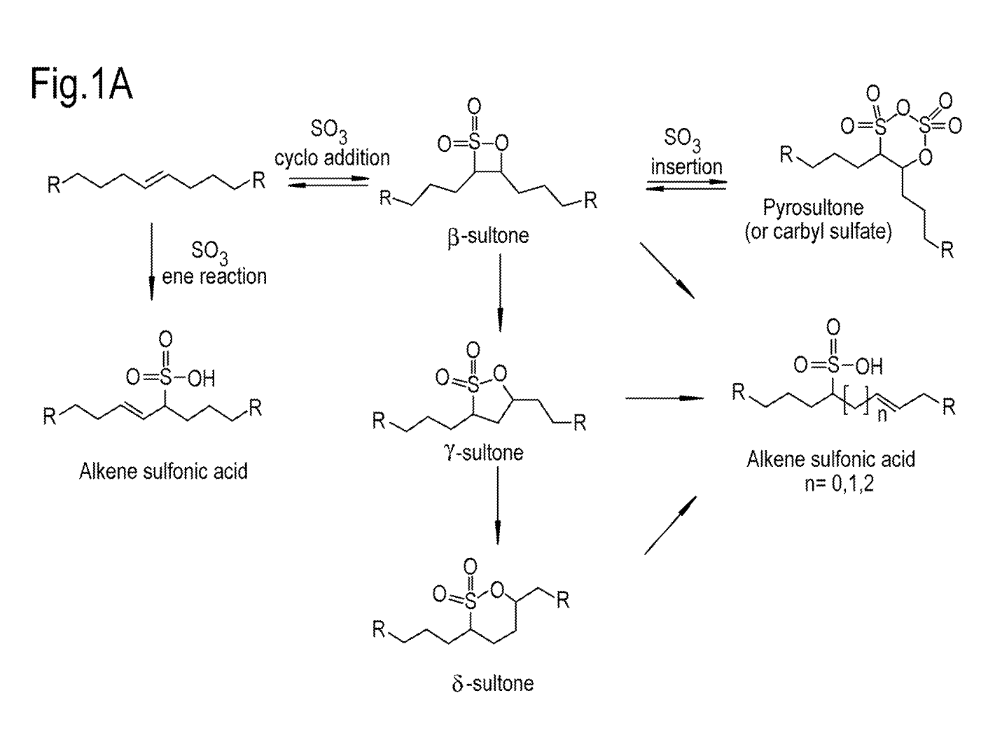

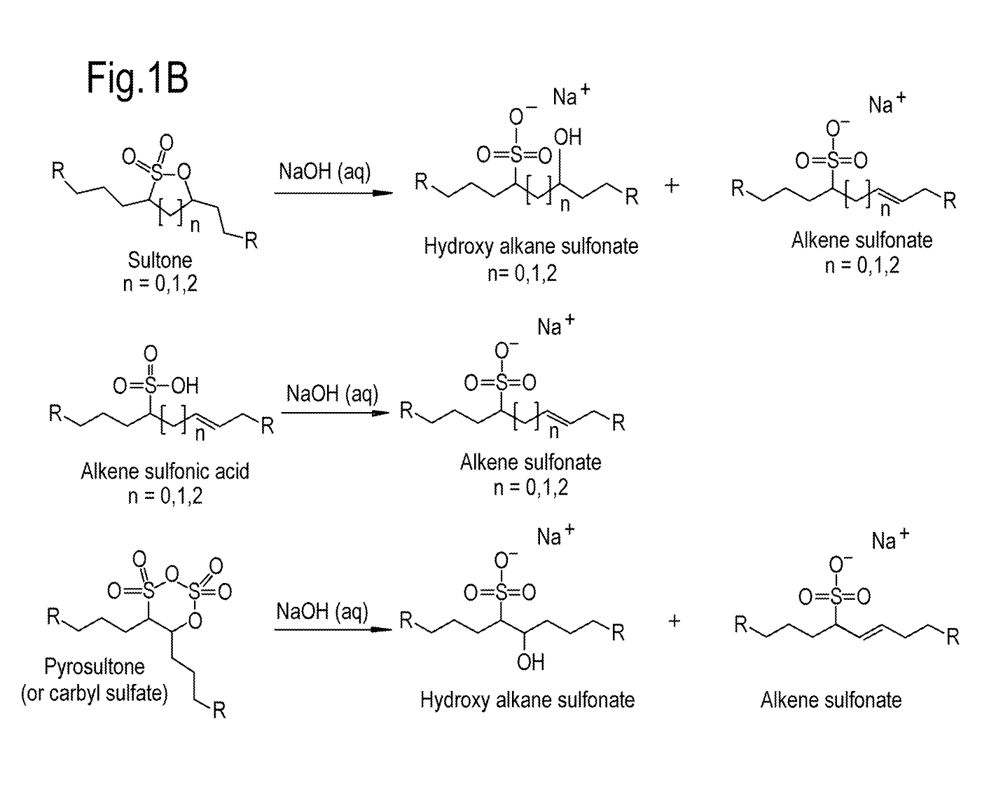

The composition used in the present invention is an internal olefin sulfonate composition which comprises internal olefin sulfonate molecules. An internal olefin sulfonate molecule is an alkene or hydroxyalkane substituted by one or more sulfonate groups. An internal olefin sulfonate molecule may be substituted by one or more hydroxy groups. Examples of such internal olefin sulfonate molecules are shown in FIG. 1B, which shows hydroxy alkane sulfonates (HAS) and alkene sulfonates (OS).

Thus, the composition used in the present invention comprises an internal olefin sulfonate. Said internal olefin sulfonate (IOS) is prepared from an internal olefin by sulfonation. Within the present specification, an internal olefin and an IOS comprise a mixture of internal olefin molecules and a mixture of IOS molecules, respectively. That is to say, within the present specification, “internal olefin” as such refers to a mixture of internal olefin molecules whereas “internal olefin molecule” refers to one of the components from such internal olefin. Analogously, within the present specification, “IOS” or “internal olefin sulfonate” as such refers to a mixture of IOS molecules whereas “IOS molecule” or “internal olefin sulfonate molecule” refers to one of the components from such IOS. Said molecules differ from each other for example in terms of carbon number and/or branching degree.

Branched IOS molecules are IOS molecules derived from internal olefin molecules which comprise one or more branches. Linear IOS molecules are IOS molecules derived from internal olefin molecules which are linear, that is to say which comprise no branches (unbranched internal olefin molecules). An internal olefin may be a mixture of linear internal olefin molecules and branched internal olefin molecules. Analogously, an IOS may be a mixture of linear IOS molecules and branched IOS molecules.

An internal olefin or IOS may be characterised by its carbon number and/or linearity.

In case reference is made to an average carbon number, this means that the internal olefin or IOS in question is a mixture of molecules which differ from each other in terms of carbon number. Within the present specification, said average carbon number is determined by multiplying the number of carbon atoms of each molecule by the weight fraction of that molecule and then adding the products, resulting in a weight average carbon number. The average carbon number may be determined by gas chromatography (GC) analysis of the internal olefin.

Within the present specification, linearity is determined by dividing the weight of linear molecules by the total weight of branched, linear and cyclic molecules. Substituents (like the sulfonate group and optional hydroxy group in the internal olefin sulfonates) on the carbon chain are not seen as branches. The linearity may be determined by gas chromatography (GC) analysis of the internal olefin.

The foregoing passages regarding (average) carbon number and linearity apply analogously to the second surfactant as further described below.

In the present invention, the internal olefin sulfonate composition comprises an internal olefin sulfonate (IOS). Preferably at least 60 wt. %, more preferably at least 70 wt. %, more preferably at least 80 wt. %, most preferably at least 90 wt. % of said IOS is linear. For example, 60 to 100 wt. %, more suitably 70 to 99 wt. %, most suitably 80 to 99 wt. % of said IOS may be linear. Branches in said IOS may include methyl, ethyl and/or higher molecular weight branches including propyl branches.

Further, preferably, said IOS is not substituted by groups other than sulfonate groups and optionally hydroxy groups. Further, preferably, said IOS has an average carbon number in the range of from 5 to 30, more preferably 8 to 28, more preferably 10 to 27, more preferably 12 to 26, more preferably 13 to 25, more preferably 14 to 24, more 15 to 24, more preferably 16 to 24, more preferably 17 to 23, more preferably 18 to 23, most preferably 18 to 22.

Still further, preferably, said IOS may have a carbon number distribution within broad ranges. For example, in the present invention, said IOS may be selected from the group consisting of C₁₅₋₁₈ IOS, C₁₉₋₂₃ IOS, C₂₀₋₂₄ IOS, C₂₄₋₂₈ IOS and mixtures thereof, wherein “IOS” stands for “internal olefin sulfonate”. IOS suitable for use in the present invention include those from the ENORDET™ O series of surfactants commercially available from Shell Chemicals Company.

“C₁₅₋₁₈ internal olefin sulfonate” (C₁₅₋₁₈ IOS) as used herein means a mixture of internal olefin sulfonate molecules wherein the mixture has an average carbon number of from 16 to 17 and at least 50% by weight, preferably at least 65% by weight, more preferably at least 75% by weight, most preferably at least 90% by weight, of the internal olefin sulfonate molecules in the mixture contain from 15 to 18 carbon atoms.

“C₁₉₋₂₃ internal olefin sulfonate” (C₁₉₋₂₃ IOS) as used herein means a mixture of internal olefin sulfonate molecules wherein the mixture has an average carbon number of from 21 to 23 and at least 50% by weight, preferably at least 60% by weight, of the internal olefin sulfonate molecules in the mixture contain from 19 to 23 carbon atoms.

“C₂₀₋₂₄ internal olefin sulfonate” (C₂₀₋₂₄ IOS) as used herein means a mixture of internal olefin sulfonate molecules wherein the mixture has an average carbon number of from 20 to 23 and at least 50% by weight, preferably at least 65% by weight, more preferably at least 75% by weight, most preferably at least 90% by weight, of the internal olefin sulfonate molecules in the mixture contain from 20 to 24 carbon atoms.

“C₂₄₋₂₈ internal olefin sulfonate” (C₂₄₋₂₈ IOS) as used herein means a mixture of internal olefin sulfonate molecules wherein the mixture has an average carbon number of from 24.5 to 27 and at least 40% by weight, preferably at least 45% by weight, of the internal olefin sulfonate molecules in the mixture contain from 24 to 28 carbon atoms.

Further, for the internal olefin sulfonates which are substituted by sulfonate groups, the cation may be any cation, such as an ammonium, alkali metal or alkaline earth metal cation, preferably an ammonium or alkali metal cation.

An IOS molecule is made from an internal olefin molecule whose double bond is located anywhere along the carbon chain except at a terminal carbon atom. Internal olefin molecules may be made by double bond isomerization of alpha olefin molecules whose double bond is located at a terminal position. Generally, such isomerization results in a mixture of internal olefin molecules whose double bonds are located at different internal positions. The distribution of the double bond positions is mostly thermodynamically determined. Further, that mixture may also comprise a minor amount of non-isomerized alpha olefins. Still further, because the starting alpha olefin may comprise a minor amount of paraffins (non-olefinic alkanes), the mixture resulting from alpha olefin isomeration may likewise comprise that minor amount of unreacted paraffins.

In the present invention, the amount of alpha olefins in the internal olefin may be up to 5%, for example 1 to 4 wt. % based on total composition. Further, in the present invention, the amount of paraffins in the internal olefin may be up to 2 wt. %, for example up to 1 wt. % based on total composition.

Suitable processes for making an internal olefin include those described in U.S. Pat. No. 5,510,306, U.S. Pat No. 5,633,422, U.S. Pat. No. 5,648,584, U.S. Pat. No. 5,648,585, U.S. Pat. No. 5,849,960, EP0830315B1 and “Anionic Surfactants: Organic Chemistry”, Surfactant Science Series, volume 56, Chapter 7, Marcel Dekker, Inc., N.Y., 1996, ed. H. W. Stacke.

In the sulfonation step, the internal olefin is contacted with a sulfonating agent. Referring to FIG. 1A, reaction of the sulfonating agent with an internal olefin leads to the formation of cyclic intermediates known as beta-sultones, which can undergo isomerization to unsaturated sulfonic acids and the more stable gamma- and delta-sultones.

In a next step, sulfonated internal olefin from the sulfonation step is contacted with a base containing solution. Referring to FIG. 1B, in this step, beta-sultones are converted into beta-hydroxyalkane sulfonates, whereas gamma- and delta-sultones are converted into gamma-hydroxyalkane sulfonates and delta-hydroxyalkane sulfonates, respectively. Part of said hydroxyalkane sulfonates may be dehydrated into alkene sulfonates.

Thus, referring to FIGS. 1A and 1B, an IOS comprises a range of different molecules, which may differ from one another in terms of carbon number, being branched or unbranched, number of branches, molecular weight and number and distribution of functional groups such as sulfonate and hydroxyl groups. An IOS comprises both hydroxyalkane sulfonate molecules and alkene sulfonate molecules and possibly also di-sulfonate molecules. Hydroxyalkane sulfonate molecules and alkene sulfonate molecules are shown in FIG. 1B. Di-sulfonate molecules (not shown in FIG. 1B) originate from a further sulfonation of for example an alkene sulfonic acid as shown in FIG. 1A. The IOS may comprise at least 30% hydroxyalkane sulfonate molecules, up to 70% alkene sulfonate molecules and up to 15% di-sulfonate molecules. Suitably, the IOS comprises from 40% to 95% hydroxyalkane sulfonate molecules, from 5% to 50% alkene sulfonate molecules and from 0% to 10% di-sulfonate molecules. Beneficially, the IOS comprises from 50% to 90% hydroxyalkane sulfonate molecules, from 10% to 40% alkene sulfonate molecules and from less than 1% to 5% di-sulfonate molecules. More beneficially, the IOS comprises from 70% to 90% hydroxyalkane sulfonate molecules, from 10% to 30% alkene sulfonate molecules and less than 1% di-sulfonate molecules. The composition of the IOS may be measured using a liquid chromatography/mass spectrometry (LC-MS) technique.

U.S. Pat. No. 4,183,867, U.S. Pat. No. 4,248,793 and EP0351928A1 disclose processes which can be used to make internal olefin sulfonates. Further, the internal olefin sulfonates may be synthesized in a way as described by Van Os et al. in “Anionic Surfactants: Organic Chemistry”, Surfactant Science Series 56, ed. Stacke H. W., 1996, Chapter 7: Olefin sulfonates, pages 367-371.

The internal olefin sulfonate composition used in the present invention additionally comprises a second surfactant which is selected from the group consisting of:

(1) a compound of the formula (I)

R—O—[R′—O]ₓ—X Formula (I)

wherein R is a hydrocarbyl group, R′—O is an alkylene oxide group, x is the number of alkylene oxide groups R′—O, and X is selected from the group consisting of: (i) a hydrogen atom; (ii) a group comprising a carboxylate moiety; and (iii) a group comprising a sulfonate moiety;

(2) an alpha olefin sulfonate; and

(3) an alkyl aromatic sulfonate.

In one embodiment of the invention, the second surfactant is a compound of the above formula (I). The hydrocarbyl group R in said formula (I) may be aliphatic or aromatic, suitably aliphatic. When said hydrocarbyl group R is aliphatic, it may be an alkyl group, cycloalkyl group or alkenyl group, suitably an alkyl group. Said hydrocarbyl group may be substituted by another hydrocarbyl group as described hereinbefore or by a substituent which contains one or more heteroatoms, such as a hydroxy group or an alkoxy group.

The non-alkoxylated alcohol R—OH, from which the hydrocarbyl group R in the above formula (I) originates, may be an alcohol containing 1 hydroxyl group (mono-alcohol) or an alcohol containing of from 2 to 6 hydroxyl groups (poly-alcohol). Suitable examples of poly-alcohols are diethylene glycol, dipropylene glycol, glycerol, pentaerythritol, trimethylolpropane, sorbitol and mannitol. Preferably, in the present invention, the hydrocarbyl group R in the above formula (I) originates from a non-alkoxylated alcohol R—OH which only contains 1 hydroxyl group (mono-alcohol). Further, said alcohol may be a primary or secondary alcohol, preferably a primary alcohol.

The non-alkoxylated alcohol R—OH, wherein R is an aliphatic group and from which the hydrocarbyl group R in the above formula (I) originates, may comprise a range of different molecules which may differ from one another in terms of carbon number for the aliphatic group R, the aliphatic group R being branched or unbranched, number of branches for the aliphatic group R, and molecular weight.

Preferably, the hydrocarbyl group R in the above formula (I) is an alkyl group. Said alkyl group may be linear or branched, and has an average carbon number within wide ranges, such as from 5 to 30, suitably 5 to 25, more suitably 8 to 20, more suitably 9 to 18, more suitably 9 to 16, most suitably 9 to 14. In a case where said alkyl group is linear and contains 3 or more carbon atoms, the alkyl group is attached either via its terminal carbon atom or an internal carbon atom to the oxygen atom, preferably via its terminal carbon atom.

The alkylene oxide groups R′—O in the above formula (I) may comprise any alkylene oxide groups. For example, said alkylene oxide groups may comprise ethylene oxide groups, propylene oxide groups and butylene oxide groups or a mixture thereof, such as a mixture of ethylene oxide and propylene oxide groups. Preferably, said alkylene oxide groups consist of ethylene oxide groups or propylene oxide groups or a mixture of ethylene oxide and propylene oxide groups. In case of a mixture of different alkylene oxide groups, the mixture may be random or blockwise.

In the above formula (I), x represents the number of alkylene oxide groups R′—O. In the present invention, the average value for x may be at least 0.5, suitably of from 1 to 50, more suitably of from 1 to 40, more suitably of from 2 to 35, more suitably of from 2 to 30, more suitably of from 2 to 25, more suitably of from 3 to 20, more suitably of from 3 to 18, more suitably of from 4 to 16, most suitably of from 5 to 12.

The non-alkoxylated alcohol R—OH, from which the hydrocarbyl group R in the above formula (I) originates, may be prepared in any way. For example, a primary aliphatic alcohol may be prepared by hydroformylation of a branched olefin. Preparations of branched olefins are described in U.S. Pat. No. 5,510,306, U.S. Pat. No. 5,648,584 and U.S. Pat. No. 5,648,585. Preparations of branched long chain aliphatic alcohols are described in U.S. Pat. No. 5,849,960, U.S. Pat. No. 6,150,222, U.S. Pat. No. 6,222,077.

The above-mentioned (non-alkoxylated) alcohol R—OH, from which the hydrocarbyl group R in the above formula (I) originates, may be alkoxylated by reacting with alkylene oxide in the presence of an appropriate alkoxylation catalyst. The alkoxylation catalyst may be potassium hydroxide or sodium hydroxide which is commonly used commercially. Alternatively, a double metal cyanide catalyst may be used, as described in U.S. Pat. No. 6,977,236. Still further, a lanthanum-based or a rare earth metal-based alkoxylation catalyst may be used, as described in U.S. Pat. No. 5,059,719 and U.S. Pat. No. 5,057,627. The alkoxylation reaction temperature may range from 90° C. to 250° C., suitably 120 to 220° C., and super atmospheric pressures may be used if it is desired to maintain the alcohol substantially in the liquid state.

Preferably, the alkoxylation catalyst is a basic catalyst, such as a metal hydroxide, wick catalyst contains a Group IA or Group IIA metal ion. Suitably, when the metal ion is a Group IA metal ion, it is a lithium, sodium, potassium or cesium ion, more suitably a sodium or potassium ion, most suitably a potassium ion. Suitably, when the metal ion is a Group IIA metal ion, it is a magnesium, calcium or barium ion. Thus, suitable examples of the alkoxylation catalyst are lithium hydroxide, sodium hydroxide, potassium hydroxide, cesium hydroxide, magnesium hydroxide, calcium hydroxide and barium hydroxide, more suitably sodium hydroxide and potassium hydroxide, most suitably potassium hydroxide. Usually, the amount of such alkoxylation catalyst is of from 0.01 to 5 wt. %, more suitably 0.05 to 1 wt. %, most suitably 0.1 to 0.5 wt. %, based on the total weight of the catalyst, alcohol and alkylene oxide (i.e. the total weight of the final reaction mixture).

The alkoxylation procedure serves to introduce a desired average number of alkylene oxide units per mole of alcohol alkoxylate (that is alkoxylated alcohol), wherein different numbers of alkylene oxide units are distributed over the alcohol alkoxylate molecules. For example, treatment of an alcohol with/moles of alkylene oxide per mole of primary alcohol serves to effect the alkoxylation of each alcohol molecule with 7 alkylene oxide groups, although a substantial proportion of the alcohol will have become combined with more than 7 alkylene oxide groups and an approximately equal proportion will have become combined with less than 7. In a typical alkoxylation product mixture, there may also be a minor proportion of unreacted alcohol.

In the above-mentioned embodiment of the invention, wherein the second surfactant is of the above formula (I), X in the above formula (I) may be a hydrogen atom, in which case the second surfactant is an alkoxylated alcohol. Suitable examples of commercially available alkoxylated alcohol mixtures include the NEODOL (NEODOL, as used throughout this text, is a trademark) alkoxylated alcohols, sold by Shell Chemical Company, including mixtures of ethoxylates of C₉, C₁₀ and C₁₁ alcohols wherein the average value for the number of the ethylene oxide groups is 8 (NEODOL 91-8 alcohol ethoxylate); mixtures of ethoxylates of C₁₄ and C₁₅ alcohols wherein the average value for the number of the ethylene oxide groups is 7 (NEODOL 45-7 alcohol ethoxylate); and mixtures of ethoxylates of C₁₂, C₁₃, C₁₄ and C₁₅ alcohols wherein the average value for the number of the ethylene oxide groups is 12 (NEODOL 25-12 alcohol ethoxylate).

Further, in the above-mentioned embodiment of the invention, wherein the second surfactant is of the above formula (I), X in the above formula (I) may be a group comprising a carboxylate or sulfonate moiety, which are anionic moieties.

In the above-mentioned embodiments of the invention, wherein the second surfactant is of the above formula (I) and X in the above formula (I) is a group comprising an anionic moiety, the cation may be any cation, such as an ammonium, alkali metal or alkaline earth metal cation, preferably an ammonium or alkali metal cation. Surfactants of the formula (I) wherein X is a group comprising an anionic moiety may be prepared from the above-described alkoxylated alcohols of the formula R—O—[R′—O]ₓ—H, as is further described hereinbelow.

In a case where X in the above formula (I) is a group comprising a carboxylate moiety, the second surfactant is of the formula (II)

R—O—[R′—O]ₓ-L-C(═O)O⁻ Formula (II)

wherein R, R′ and x have the above-described meanings and L is an alkyl group, suitably a C₁-C₄ alkyl group, which may be unsubstituted or substituted, and wherein the —C(═O)O⁻ moiety is the carboxylate moiety.

The alkoxylated alcohol R—O—[R′—O]ₓ—H may be carboxylated by any one of a number of well-known methods. It may be reacted, preferably after deprotonation with a base, with a halogenated carboxylic acid, for example chloroacetic acid, or a halogenated carboxylate, for example sodium chloroacetate. Alternatively, the alcoholic end group may be oxidized to yield a carboxylic acid, in which case the number x (number of alkylene oxide groups) is reduced by 1. Any carboxylic acid product may then be neutralized with an alkali metal base to form a carboxylate surfactant.

In a specific example, an alkoxylated alcohol may be reacted with potassium t-butoxide and initially heated at for example 60° C. under reduced pressure for for example 10 hours. It would be allowed to cool and then sodium chloroacetate would be added to the mixture. The reaction temperature would be increased to for example 90° C. under reduced pressure for for example 20-21 hours. It would be cooled to room temperature and water and hydrochloric acid would be added. This would be heated to for example 90° C. for for example 2 hours. The organic layer may be extracted by adding ethyl acetate and washing it with water.

In a case where X in the above formula (I) is a group comprising a sulfonate moiety, the second surfactant is of the formula (III)

R—O—[R′—O]ₓ-L-S(═O)₂O⁻ Formula (III)

wherein R, R′ and x have the above-described meanings and L is an alkyl group, suitably a C₁-C₄ alkyl group, which may be unsubstituted or substituted, and wherein the —S(═O)₂O⁻ moiety is the sulfonate moiety.

The alkoxylated alcohol R—O—[R′—O]ₓ—H may be sulfonated by any one of a number of well-known methods. It may be reacted, preferably after deprotonation with a base, with a halogenated sulfonic acid, for example chloroethyl sulfonic acid, or a halogenated sulfonate, for example sodium chloroethyl sulfonate. Any resulting sulfonic acid product may then be neutralized with an alkali metal base to form a sulfonate surfactant.

Particularly suitable sulfonate surfactants are glycerol sulfonates. Glycerol sulfonates may be prepared by reacting the alkoxylated alcohol R—O—[R′—O]ₓ—H with epichlorohydrin, preferably in the presence of a catalyst such as tin tetrachloride, for example at from 110 to 120° C. and for from 3 to 5 hours at a pressure of 14.7 to 15.7 psia (100 to 110 kPa) in toluene. Next, the reaction product is reacted with a base such as sodium hydroxide or potassium hydroxide, for example at from 85 to 95° C. for from 2 to 4 hours at a pressure of 14.7 to 15.7 psia (100 to 110 kPa). The reaction mixture is cooled and separated in two layers. The organic layer is separated and the product isolated. It may then be reacted with sodium bisulfite and sodium sulfite, for example at from 140 to 160° C. for from 3 to 5 hours at a pressure of 60 to 80 psia (400 to 550 kPa). The reaction is cooled and the product glycerol sulfonate is recovered. Such glycerol sulfonate has the formula R—O—[R′—O]ₓ—CH₂—CH(OH)—CH₂—S(═O)₂O⁻.

In another embodiment of the invention, the second surfactant is an alpha olefin sulfonate (AOS). An AOS differs from an IOS in that an AOS is made from an alpha olefin, whose double bond is located at a terminal position. Unless indicated otherwise hereinbelow, the above disclosures regarding IOS as a first surfactant equally apply to AOS as a second surfactant in the present invention.

In the above-mentioned embodiment, said AOS preferably has an average carbon number in the range of from 5 to 30, more preferably 8 to 25, more preferably 8 to 22, more preferably 9 to 20, more preferably 10 to 18, most preferably 12 to 16.

In yet another embodiment of the invention, the second surfactant is an alkyl aromatic sulfonate. Within the present specification, by “alkyl aromatic sulfonate” reference is made to an aromatic compound which is substituted by both an alkyl group and a sulfonate moiety. Such alkyl aromatic sulfonate may be shown by the formula (IV)

R—Ar—S(═O)₂O⁻ Formula (IV)

wherein R is an alkyl group and Ar is an aromatic group.

The alkyl group R in the above formula (IV) may be linear or branched, preferably linear. Further, it may have an average carbon number within wide ranges, for example of from 1 to 40, suitably 1 to 30, more suitably 1 to 20, more suitably 5 to 18, more suitably 8 to 16, more suitably 10 to 14, most suitably 10 to 13 carbon atoms. In a case where said alkyl group is linear and contains 3 or more carbon atoms, the alkyl group is attached either via its terminal carbon atom or an internal carbon atom to the benzene ring, preferably via its internal carbon atom.

The aromatic group Ar in the above formula (IV) may be a phenyl group or a group comprising 2 or more phenyl groups which may be fused, such as naphthalene. Preferably, the aromatic group Ar is a phenyl group. Said phenyl group is substituted by the above-described alkyl group R and by a sulfonate moiety. Preferably, the alkyl group R is attached to the para-position of the benzene ring relative to the sulfonate moiety. In addition to said 2 substituents, the phenyl group may be substituted by 1 or more, preferably 1, alkyl groups as described hereinbefore in relation to the alkyl group R, with the proviso that such other alkyl group preferably has a lower average carbon number, suitably of from 1 to 10, more suitably 1 to 8, more suitably 1 to 6, more suitably 1 to 4, most suitably 1 to 3 carbon atoms, for example a methyl group.

In the present invention, a cosolvent (or solubilizer) may be added to (further) increase the solubility of the surfactants in the internal olefin sulfonate composition used in the present invention and/or in the below-mentioned injectable fluid comprising said composition. Suitable examples of cosolvents are polar cosolvents, including lower alcohols (for example sec-butanol and isopropyl alcohol) and polyethylene glycol. Any amount of cosolvent needed to dissolve all of the surfactant at a certain salt concentration (salinity) may be easily determined by a skilled person through routine tests.

Still further, the internal olefin sulfonate composition used in the present invention may comprise a base (herein also referred to as “alkali”), preferably an aqueous soluble base, including alkali metal containing bases such as for example sodium carbonate and sodium hydroxide.

Thus, the present invention relates to a method of treating a hydrocarbon containing formation, comprising the following steps:

a) providing the composition which comprises an internal olefin sulfonate and a second surfactant as described above to at least a portion of the hydrocarbon containing formation wherein the temperature is 60° C. or higher and the concentration of divalent cations is 100 or more parts per million by weight (ppmw); and

b) allowing the surfactants from the composition to interact with the hydrocarbons in the hydrocarbon containing formation.

In the method of the present invention, the temperature is 60° C. or higher. By said temperature reference is made to the temperature in the hydrocarbon containing formation. Preferably, said temperature is of from 60 to 200° C., more preferably of from 60 to 150° C. In practice, said temperature may vary strongly between different hydrocarbon containing formations. In the present invention, said temperature is at least 60° C., suitably at least 80° C., more suitably at least 90° C., most suitably at least 100° C. Further, said temperature may be at most 200° C., suitably at most 180° C., more suitably at most 160° C., most suitably at most 150° C.

Further, in the method of the present invention, the concentration of divalent cations is 100 or more parts per million by weight (ppmw). By said concentration of divalent cations reference is made to the concentration of divalent cations in the water or brine in combination with which the composition used in the present invention which comprises an internal olefin sulfonate and a second surfactant as described above, is provided to at least a portion of the hydrocarbon containing formation. Said water or brine may originate from the hydrocarbon containing formation or from any other source, such as river water, sea water or aquifer water. A suitable example is sea water which may contain 1,700 ppmw of divalent cations. Suitably, said divalent cations comprise calcium (Ca²⁺) and magnesium (Mg²⁺) cations. Further, preferably, said concentration of divalent cations is of from 100 to 25,000 ppmw. In practice, said concentration of divalent cations may vary strongly between different sources. In the present invention, said concentration of divalent cations is at least 100 ppmw, suitably at least 200 ppmw, more suitably at least 500 ppmw, more suitably at least 1,000 ppmw, more suitably at least 1,500 ppmw, more suitably at least 2,000 ppmw, most suitably at least 3,000 ppmw. Further, said concentration of divalent cations may be at most 25,000 ppmw, suitably at most 20,000 ppmw, more suitably at most 15,000 ppmw, more suitably at most 10,000 ppmw, suitably at most 8,000 ppmw, more suitably at most 6,000 ppmw, most suitably at most 5,000 ppmw.

Further, in the present invention, the salinity of said water or brine, which may originate from the hydrocarbon containing formation or from any other source, may be of from 0.5 to 30 wt. % or 0.5 to 20 wt. % or 0.5 to 10 wt. % or 1 to 6 wt. %. By said “salinity” reference is made to the concentration of total dissolved solids (% TDS), wherein the dissolved solids comprise dissolved salts. Said salts may be salts comprising divalent cations, such as magnesium chloride and calcium chloride, and salts comprising monovalent cations, such as sodium chloride and potassium chloride. Sea water may have a salinity (% TDS) of 3.6 wt. %.

In the above-mentioned method of treating a hydrocarbon containing formation, the surfactants (an internal olefin sulfonate (IOS) and a second surfactant) are applied in cEOR (chemical Enhanced Oil Recovery) at the location of the hydrocarbon containing formation, more in particular by providing the above-described IOS composition to at least a portion of the hydrocarbon containing formation and then allowing the surfactants from said composition to interact with the hydrocarbons in the hydrocarbon containing formation. Said hydrocarbon containing formation may be a crude oil-bearing formation.

Normally, surfactants for enhanced hydrocarbon recovery are transported to a hydrocarbon recovery location and stored at that location in the form of an aqueous solution containing for example 30 to 35 wt. % of the surfactant(s). At the hydrocarbon recovery location, such solution would then be further diluted to a 0.05-2 wt. % solution, before it is injected into a hydrocarbon containing formation. By such dilution, an aqueous fluid is formed which fluid can be injected into the hydrocarbon containing formation, that is to say an injectable fluid. Advantageously, in the present invention, the water or brine used in such further dilution, which water or brine may originate from the hydrocarbon containing formation (from which hydrocarbons are to be recovered) or from any other source, may have a relatively high concentration of divalent cations, suitably in the above-described ranges. One of the advantages is that such water or brine no longer has to be pre-treated such as to remove said divalent cations, thereby resulting in significant savings in time and costs.

The total amount of the surfactants in said injectable fluid may be of from 0.05 to 2 wt. %, preferably 0.1 to 1.5 wt. %, more preferably 0.1 to 1.0 wt. %, most preferably 0.2 to 0.5 wt. %.

Hydrocarbons may be produced from hydrocarbon containing formations through wells penetrating such formations. “Hydrocarbons” are generally defined as molecules formed primarily of carbon and hydrogen atoms such as oil and natural gas. Hydrocarbons may also include other elements, such as halogens, metallic elements, nitrogen, oxygen and/or sulfur. Hydrocarbons derived from a hydrocarbon containing formation may include kerogen, bitumen, pyrobitumen, asphaltenes, oils or combinations thereof. Hydrocarbons may be located within or adjacent to mineral matrices within the earth. Matrices may include sedimentary rock, sands, silicilytes, carbonates, diatomites and other porous media.

A “hydrocarbon containing formation” may include one or more hydrocarbon containing layers, one or more non-hydrocarbon containing layers, an overburden and/or an underburden. An overburden and/or an underburden includes one or more different types of impermeable materials. For example, overburden/underburden may include rock, shale, mudstone, or wet/tight carbonate (that is to say an impermeable carbonate without hydrocarbons). For example, an underburden may contain shale or mudstone. In some cases, the overburden/underburden may be somewhat permeable. For example, an underburden may be composed of a permeable mineral such as sandstone or limestone.

Properties of a hydrocarbon containing formation may affect how hydrocarbons flow through an underburden/overburden to one or more production wells. Properties include porosity, permeability, pore size distribution, surface area, salinity or temperature of formation. Overburden/underburden properties in combination with hydrocarbon properties, capillary pressure (static) characteristics and relative permeability (flow) characteristics may affect mobilisation of hydrocarbons through the hydrocarbon containing formation.

Fluids (for example gas, water, hydrocarbons or combinations thereof) of different densities may exist in a hydrocarbon containing formation. A mixture of fluids in the hydrocarbon containing formation may form layers between an underburden and an overburden according to fluid density. Gas may form a top layer, hydrocarbons may form a middle layer and water may form a bottom layer in the hydrocarbon containing formation. The fluids may be present in the hydrocarbon containing formation in various amounts. Interactions between the fluids in the formation may create interfaces or boundaries between the fluids. Interfaces or boundaries between the fluids and the formation may be created through interactions between the fluids and the formation. Typically, gases do not form boundaries with other fluids in a hydrocarbon containing formation. A first boundary may form between a water layer and underburden. A second boundary may form between a water layer and a hydrocarbon layer. A third boundary may form between hydrocarbons of different densities in a hydrocarbon containing formation.

Production of fluids may perturb the interaction between fluids and between fluids and the overburden/underburden. As fluids are removed from the hydrocarbon containing formation, the different fluid layers may mix and form mixed fluid layers. The mixed fluids may have different interactions at the fluid boundaries. Depending on the interactions at the boundaries of the mixed fluids, production of hydrocarbons may become difficult.

Quantification of energy required for interactions (for example mixing) between fluids within a formation at an interface may be difficult to measure. Quantification of energy levels at an interface between fluids may be determined by generally known techniques (for example spinning drop tensiometer). Interaction energy requirements at an interface may be referred to as interfacial tension. “Interfacial tension” as used herein, refers to a surface free energy that exists between two or more fluids that exhibit a boundary. A high interfacial tension value (for example greater than 10 dynes/cm) may indicate the inability of one fluid to mix with a second fluid to form a fluid emulsion. As used herein, an “emulsion” refers to a dispersion of one immiscible fluid into a second fluid by addition of a compound that reduces the interfacial tension between the fluids to achieve stability. The inability of the fluids to mix may be due to high surface interaction energy between the two fluids. Low interfacial tension values (for example less than 1 dyne/cm) may indicate less surface interaction between the two immiscible fluids. Less surface interaction energy between two immiscible fluids may result in the mixing of the two fluids to form an emulsion. Fluids with low interfacial tension values may be mobilised to a well bore due to reduced capillary forces and subsequently produced from a hydrocarbon containing formation. Thus, in surfactant cEOR, the mobilisation of residual oil is achieved through surfactants which generate a sufficiently low crude oil/water interfacial tension (IFT) to give a capillary number large enough to overcome capillary forces and allow the oil to flow.

Mobilisation of residual hydrocarbons retained in a hydrocarbon containing formation may be difficult due to viscosity of the hydrocarbons and capillary effects of fluids in pores of the hydrocarbon containing formation. As used herein “capillary forces” refers to attractive forces between fluids and at least a portion of the hydrocarbon containing formation. Capillary forces may be overcome by increasing the pressures within a hydrocarbon containing formation. Capillary forces may also be overcome by reducing the interfacial tension between fluids in a hydrocarbon containing formation. The ability to reduce the capillary forces in a hydrocarbon containing formation may depend on a number of factors, including the temperature of the hydrocarbon containing formation, the salinity of water in the hydrocarbon containing formation, and the composition of the hydrocarbons in the hydrocarbon containing formation.

As production rates decrease, additional methods may be employed to make a hydrocarbon containing formation more economically viable. Methods may include adding sources of water (for example brine, steam), gases, polymers or any combinations thereof to the hydrocarbon containing formation to increase mobilisation of hydrocarbons.

In the present invention, the hydrocarbon containing formation is thus treated with the diluted or not-diluted surfactants containing solution, as described above. Interaction of said solution with the hydrocarbons may reduce the interfacial tension of the hydrocarbons with one or more fluids in the hydrocarbon containing formation. The interfacial tension between the hydrocarbons and an overburden/underburden of a hydrocarbon containing formation may be reduced. Reduction of the interfacial tension may allow at least a portion of the hydrocarbons to mobilise through the hydrocarbon containing formation.

The ability of the surfactants containing solution to reduce the interfacial tension of a mixture of hydrocarbons and fluids may be evaluated using known techniques. The interfacial tension value for a mixture of hydrocarbons and water may be determined using a spinning drop tensiometer. An amount of the surfactants containing solution may be added to the hydrocarbon/water mixture and the interfacial tension value for the resulting fluid may be determined.

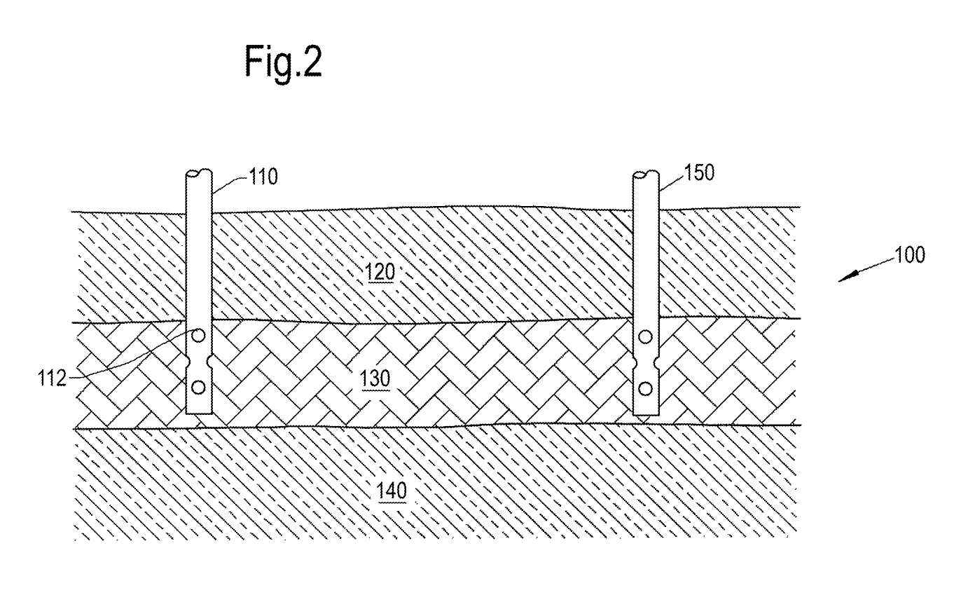

The surfactants containing solution, diluted or not diluted, may be provided (for example injected in the form of a diluted aqueous fluid) into hydrocarbon containing formation 100 through injection well 110 as depicted in FIG. 2. Hydrocarbon containing formation 100 may include overburden 120, hydrocarbon layer 130 (the actual hydrocarbon containing formation), and underburden 140. Injection well 110 may include openings 112 (in a steel casing) that allow fluids to flow through hydrocarbon containing formation 100 at various depth levels. Low salinity water may be present in hydrocarbon containing formation 100.

The surfactants from the surfactants containing solution may interact with at least a portion of the hydrocarbons in hydrocarbon layer 130. This interaction may reduce at least a portion of the interfacial tension between one or more fluids (for example water, hydrocarbons) in the formation and the underburden 140, one or more fluids in the formation and the overburden 120 or combinations thereof.

The surfactants from the surfactants containing solution may interact with at least a portion of hydrocarbons and at least a portion of one or more other fluids in the formation to reduce at least a portion of the interfacial tension between the hydrocarbons and one or more fluids. Reduction of the interfacial tension may allow at least a portion of the hydrocarbons to form an emulsion with at least a portion of one or more fluids in the formation. The interfacial tension value between the hydrocarbons and one or more other fluids may be improved by the surfactants containing solution to a value of less than 0.1 dyne/cm or less than 0.05 dyne/cm or less than 0.001 dyne/cm.

At least a portion of the surfactants containing solution/hydrocarbon/fluids mixture may be mobilised to production well 150. Products obtained from the production well 150 may include components of the surfactants containing solution, methane, carbon dioxide, hydrogen sulfide, water, hydrocarbons, ammonia, asphaltenes or combinations thereof. Hydrocarbon production from hydrocarbon containing formation 100 may be increased by greater than 50% after the surfactants containing solution has been added to a hydrocarbon containing formation.

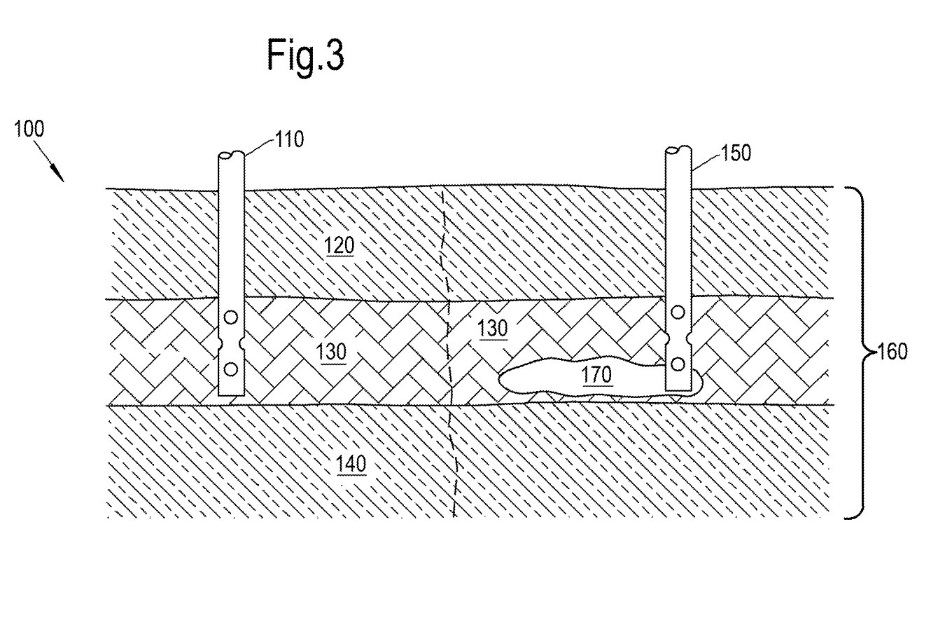

The surfactants containing solution, diluted or not diluted, may also be injected into hydrocarbon containing formation 100 through injection well 110 as depicted in FIG. 3. Interaction of the surfactants from the surfactants containing solution with hydrocarbons in the formation may reduce at least a portion of the interfacial tension between the hydrocarbons and underburden 140. Reduction of at least a portion of the interfacial tension may mobilise at least a portion of hydrocarbons to a selected section 160 in hydrocarbon containing formation 100 to form hydrocarbon pool 170. At least a portion of the hydrocarbons may be produced from hydrocarbon pool 170 in the selected section of hydrocarbon containing formation 100.

It may be beneficial under certain circumstances that an aqueous fluid, wherein the surfactants containing solution is diluted, contains inorganic salt, such as sodium chloride, sodium hydroxide, potassium chloride, ammonium chloride, sodium sulfate or sodium carbonate. Such inorganic salt may be added separately from the surfactants containing solution or it may be included in the surfactants containing solution before it is diluted in water. The addition of the inorganic salt may help the fluid disperse throughout a hydrocarbon/water mixture and to reduce surfactant loss by adsorption onto rock. This enhanced dispersion may decrease the interactions between the hydrocarbon and water interface. The decreased interaction may lower the interfacial tension of the mixture and provide a fluid that is more mobile.

1. A method of treating a hydrocarbon containing formation, comprising the following steps:
a) providing a composition which comprises an internal olefin sulfonate and a second surfactant to at least a portion of the hydrocarbon containing formation wherein the temperature is 60° C. or higher and the concentration of divalent cations is 100 or more parts per million by weight (ppmw); and
b) allowing the surfactants from the composition to interact with the hydrocarbons in the hydrocarbon containing formation; wherein
the second surfactant is selected from the group consisting of:
(1) a compound of the formula (I)
R—O—[R′—O]ₓ—X Formula (I)
wherein R is a hydrocarbyl group, R′—O is an alkylene oxide group, x is the number of alkylene oxide groups R′—O, and X is selected from the group consisting of: (i) a hydrogen atom; (ii) a group comprising a carboxylate moiety; and (iii) a group comprising a sulfonate moiety;
(2) an alpha olefin sulfonate; and
(3) an alkyl aromatic sulfonate.

2. The method of claim 1, wherein the second surfactant is the compound of the formula (I).

3. The method of claim 2, wherein X in the formula (I) is a hydrogen atom.

4. The method according to claim 2, wherein X in the formula (I) is a group comprising a carboxylate or sulfonate moiety.

5. The method of claim 1, wherein the internal olefin sulfonate is selected from the group consisting of C₁₅₋₁₈ IOS, C₁₉₋₂₃ IOS, C₂₀₋₂₄ IOS, C₂₄₋₂₈ IOS and mixtures thereof.
